(19) United States
(12) Patent Application Publication
(10) Pub. No.: US 2026/0264361 A1
(43) Pub. Date: Sep. 10, 2026

(54) RECYCLABLE MULTILAYER STRUCTURE FOR FLUID TRANSPORT, DISTRIBUTION OR STORAGE APPLICATIONS

(71) Applicant: ARKEMA FRANCE, Colombes (FR)

(72) Inventors: Claude-Olivier BOISSIERE, Serquigny (FR); Bertrand VERBAUWHEDE, Serquigny (FR); Marjorie MARCOURT, Serquigny (FR); Thomas PRENVEILLE, Serquigny (FR); Jean-Jacques FLAT, Serquigny (FR)

(73) Assignee: ARKEMA FRANCE, Colombes (FR)

(21) Appl. No.: 18/871,862

(22) PCT Filed: Jul. 4, 2023
(86) PCT No.: PCT/FR2023/051021

§ 371 Date: Dec. 5, 2024

(30) Foreign Application Priority Data
Jul. 4, 2022 (FR) FR2206726

(51) Int. Cl. B32B 1/08; B32B 7/02; B32B 27/08; B32B 27/30; B32B 27/34

(52) U.S. Cl. CPC B32B 1/08; B32B 7/02; B32B 27/08; B32B 27/306; B32B 27/34; B32B 2250/24; B32B 2439/40; B32B 2597/00

(57) ABSTRACT

A recyclable multilayer structure for the transport, distribution or storage of fluids, including from the outside inward: 1) an outer layer (I) made of polyamide, 2) a barrier layer (II) that is water-soluble at a temperature of less than or equal to 150° C., 3) an inner layer: (III) made of polyamide, and/or (IV) predominantly including at least one polyamide of aliphatic type or consisting of more than 75% of aliphatic units.

The invention relates to recyclable multilayer structures for fluid transport, distribution or storage applications.

### PRIOR ART

Every year, several million motor vehicles become end-of-life worldwide. An end-of-life motor vehicle (ELV) contains numerous toxic and pollutant products (liquids or solids): used oil, batteries, air-conditioning fluid, explosive elements from airbags, etc. When processed under unsuitable conditions, this waste may result in ground and water pollution, and also accidents. ELVs are thus regarded as hazardous waste.

A large amount of the vehicle's components can be recovered and recycled, in the form of second-hand spare parts or raw materials. Parts intended for reuse (headlamps, indicators, engine, radiator, starter, hood, fenders, doors, and the like) are dismantled and stored for resale.

Non-recyclable carcasses and parts (ferrous and non-ferrous metals, plastics, glass, rubber, etc.) are crushed for repurposing or sent to landfills.

The European Directive 2000/53/EC on end-of-life vehicles set a reuse and repurposing level of 95% by weight per vehicle from 2015.

This means that only 5% by weight should remain as ultimate waste, i.e. waste which is unfit for processing under current technical and economic conditions, and which will be incinerated or disposed of in special storage centers.

The 95% by weight that are reused and repurposed are subject to the following: Energy recovery: use of waste (oils, tires, plastics, etc.) as a means of producing energy, by direct incineration with or without other waste;

Material repurposing: Reuse or re-employment: new employment of a part which retains the same usage and is not transformed, or Recycling: operation directed toward introducing materials from waste into the production cycle, in total or partial replacement for virgin material.

A motor vehicle contains a large number of hoses, notably hoses for transporting fluids such as air, oil (for example for cooling the automatic gearbox (transmission oil cooler (TOC)), water, urea solution, a glycol-based coolant, fuel such as gasoline, in particular bio-gasoline or diesel, in particular bio-diesel, or hydrogen.

These hoses may be monolayer and/or multilayer tubular structures, in particular based on polyamide(s).

When the motor vehicle is end-of-life, certain hoses present therein may be too degraded to be reused as such, in tube form, without risk or without this leading to excessively degraded working properties.

Specifically, tubes, notably under engine hoods, are placed in a severe thermo-oxidative environment due to the heat generated by the engine, which may typically be up to 150° C., and the presence of air and thus oxygen. Each 10° C. increase in temperature typically results in a halving of tube life, and similarly in the degradation of certain additives of said tubes, such as stabilizers.

In addition, a hose for the transportation of a fuel, for example a polyamide hose which contains a plasticizer, has lost most of its plasticizer when it arrives at the end of its life and the polyamide constituting it initially present may be partly depolymerized and/or degraded and has lost most of its stabilizers, which prohibits it from being reused without risk.

Hitherto, end-of-life motor vehicle hoses have not been reused, and are often incinerated. This then contributes to global warming, the reduction of which has become one of the major challenges of the 21st century.

Current structures with an ethylene-vinyl alcohol (EVOH) barrier layer are difficult to recycle, as the PA/EVOH mixture obtained after grinding and recompounding turns out to be less efficient in terms of mechanical properties than the specifications expected, and presents a safety risk.

Specifically, after extrusion with the PA/EVOH mixture obtained, the final part contains areas of brittleness (presence of cracks and incipient failure), presenting a safety risk notably with regard to fuel.

Moreover, many motor vehicle manufacturers have set themselves the more or less long-term objective of recycling 100% of the vehicles they produce, in order to achieve an environmental impact equal to zero.

In a context of sustainable development, the use of structures with a barrier layer that can be readily disposed of in a recycling process would thus be of interest.

International patent application WO 2009/083525 describes PVOH as having barrier properties to greases and gases, but in the absence of water. Specifically, in contact with liquid water or even water vapor under “tropical” conditions (38° C. and 90% RH), PVOH's barrier properties to greases and gases disappear. These properties will be lost if the complex is washed with a solvent that is capable of dissolving the water-barrier film, or if the complex is used at temperatures above the melting point of the water-barrier film.

To remedy this problem, said international patent application uses a PVOH with a molecular weight of greater than 13 000 and a degree of hydrolysis of greater than 81%, surface-grafted with a fatty acid bearing an aliphatic chain comprising at least 12 carbon atoms, thereby affording a film having barrier properties to water, greases, gases and water vapor.

International patent application WO 2008/057763 describes a tube with at least five symmetrical layers of polyamide with a central layer made of EVOH or PVOH to avoid problems of tube fragmentation. The thickness of the barrier layer is indicated to be from 210 to 280 μm.

PVOH is mentioned but not exemplified, and nothing is indicated regarding its recyclability.

There is thus a need to propose structures with barrier properties to fuels such as gasoline, in particular bio-gasoline, diesel, in particular bio-diesel, or gases such as hydrogen, carbon dioxide, oxygen and nitrogen, close to those currently proposed, but with optimum recyclability not offered by structures with an EVOH barrier layer.

The present invention thus relates to a recyclable multilayer structure for the transport, distribution or storage of fluids, in particular for the distribution or storage of fluids, comprising from the outside inward:
1) an outer layer (I) made of polyamide, in particular aliphatic polyamide, comprising a composition comprising:
a) from 41% to 100% by weight of at least one polyamide, in particular an aliphatic polyamide, having a C/N ratio of greater than 7, preferentially greater than 8,
b) from 0 to 10% by weight of at least one polyamide, in particular an aliphatic polyamide, different from the preceding one, having a C/N ratio of less than 10, preferentially less than 8,
c) from 0 to 30% by weight of at least one impact modifier,
d) from 0 to 5% by weight of at least one additive,
e) from 0 to 14% by weight of at least one plasticizer, the sum of the constituents a)+b)+c)+d)+e) being equal to 100% by weight,
2) a barrier layer (II) that is water-soluble at a temperature of less than or equal to 150° C., in particular less than or equal to 120° C.,
3) an inner layer:
(III) made of polyamide, in particular aliphatic polyamide, comprising a composition comprising:
a) from 41% to 100% by weight of at least one polyamide, in particular an aliphatic polyamide, having a C/N ratio of greater than 7, preferentially greater than 8,
b) from 0 to 10% by weight of at least one polyamide, in particular an aliphatic polyamide different from the preceding one, having a C/N ratio of less than 10, preferentially less than 8,
c) from 0 to 30% by weight of at least one impact modifier,
d) from 0 to 5% by weight of at least one additive,
e) from 0 to 14% by weight of at least one plasticizer,
the sum of the constituents a)+b)+c)+d)+e) being equal to 100% by weight, and/or
(IV) predominantly comprising at least one polyamide of aliphatic type or consisting of more than 75% of aliphatic units, said aliphatic polyamide being chosen from:
   a polyamide, denoted A, with a mean number of carbon atoms per nitrogen atom, denoted CA, of from 4 to 8.5, advantageously from 4 to 7;
   a polyamide, denoted B, with a mean number of carbon atoms per nitrogen atom, denoted CB, of from 7 to 10, advantageously from 7.5 to 9.5;
   a polyamide, denoted C, with a mean number of carbon atoms per nitrogen atom, denoted CC, of from 9 to 18, advantageously from 10 to 18;
      layer (IV) being adjacent to layer (II) if layer (III) is also present, and layer (III) then being the innermost, or layer (IV) being the innermost if layer (III) is absent.

The inventors have thus found, unexpectedly, that using a barrier layer that is water-soluble at a temperature of less than or equal to 150° C., in particular less than or equal to 120° C., in a multilayer structure for transport, distribution or storage of fluids not only affords structures with barrier properties close to those proposed in the prior art made of EVOH, but also makes it possible to recycle said structure without any loss of performance in terms of mechanical properties relative to the expected specifications, notably after grinding, which is not the case with structures whose barriers are made of EVOH.

In one embodiment, said aliphatic polyamide is chosen from:
a polyamide, denoted B, with a mean number of carbon atoms per nitrogen atom, denoted CB, of from 7 to 10, advantageously from 7.5 to 9.5;
a polyamide, denoted C, with a mean number of carbon atoms per nitrogen atom, denoted CC, of from 9 to 18, advantageously from 10 to 18.

The term “recyclable” means that said tubular structure, after use and thus after transport, distribution or storage of fluids, can be reused, in particular after grinding and washing with hot water, i.e. used in a process for manufacturing a part, notably a new tubular structure, in particular by extrusion, while at the same time obtaining good mechanical properties, notably cold impact, low flexural modulus and high elongation at break, unlike the recycling of a structure comprising an EVOH layer.

Grinding is performed according to conventional techniques used by those skilled in the art, to a size ranging from 1 mm to 2 cm.

Said reuse of said used tubular structure may or may not be performed in admixture with virgin material.

The term “multilayer structure” denotes, for example, a tank, hose or tube comprising or consisting of several layers, notably two layers, excluding films or granules.

The term “fluid” denotes a gas or liquid used in the motor vehicle industry, in particular air, oil (for example for cooling automatic gearboxes (TOC, Transmission Oil Cooler)), water, a urea solution, a glycol-based coolant, or a fuel such as gasoline, in particular alcohol-blended gasoline, bio-gasoline or diesel, in particular bio-diesel, or hydrogen, and also a fluid chosen from carbon dioxide, oxygen and nitrogen.

In one embodiment, said fluid denotes fuels, in particular gasoline, in particular alcohol-blended gasoline, bio-gasoline or diesel, in particular bio-diesel.

In one embodiment, said fluid denotes hydrogen.

### As Regards the Composition of the Outer Layer (I)

### The Polyamide a)

Said at least one polyamide a) of layer (I) is a polyamide, in particular an aliphatic polyamide, having a C/N ratio of greater than 7, preferentially greater than 8.

It may be aliphatic, aromatic or semiaromatic.

Advantageously, it is aliphatic.

The nomenclature used to define polyamides is described in the standard ISO 1874-1:2011 “Plastics—Polyamide (PA) molding and extrusion materials—Part 1: Designation” and is well known to those skilled in the art.

According to the invention, the term “polyamide” denotes either a homopolyamide or a copolyamide.

Advantageously, said polyamide is semicrystalline.

For the purposes of the invention, throughout the description, the term “semicrystalline polyamide” denotes polyamides which have a melting point (Tm) and a heat of fusion ΔH>25 J/g, in particular >40 J/g, notably >45 J/g, and also a glass transition temperature (Tg) as determined by DSC according to the standards ISO 11357-1: 2016 and ISO 11357-2 and 3: 2013, at a heating rate of 20 K/min.

Said at least one polyamide, when it is aliphatic, is obtained from the polycondensation of at least one lactam, or from the polycondensation of at least one amino acid, or from the polycondensation of at least one diamine Xa with at least one dicarboxylic acid Yb.

When said at least one aliphatic polyamide is obtained from the polycondensation of at least one lactam, said at least one lactam may be chosen from a C6 to C18, preferentially C10 to C18, more preferentially C10 to C12 lactam. A C6 to C12 lactam is notably caprolactam, decanolactam, undecanolactam or lauryllactam.

When said at least one aliphatic polyamide is obtained from the polycondensation of at least one lactam, it may then comprise a single lactam or several lactams.

Advantageously, said at least one aliphatic polyamide is obtained from the polycondensation of a single lactam and said lactam is chosen from lauryllactam and undecanolactam, advantageously lauryllactam.

When said at least one aliphatic polyamide is obtained from the polycondensation of at least one amino acid, said at least one amino acid may be chosen from a C6 to C18, preferentially C10 to C18, more preferentially C10 to C12 amino acid.

A C6 to C12 amino acid is notably 6-aminohexanoic acid, 9-aminononanoic acid, 10-aminodecanoic acid, 10-aminoundecanoic acid, 12-aminododecanoic acid and 11-aminoundecanoic acid and also derivatives thereof, notably N-heptyl-11-aminoundecanoic acid.

When said at least one aliphatic polyamide is obtained from the polycondensation of at least one amino acid, it may then comprise a single amino acid or several amino acids.

Advantageously, said aliphatic polyamide is obtained from the polycondensation of a single amino acid and said amino acid is chosen from 11-aminoundecanoic acid and 12-aminododecanoic acid, advantageously 11-aminoundecanoic acid.

When said at least one aliphatic polyamide is obtained from the polycondensation of at least one C4-C36, preferentially C5-C18, preferentially C5-C12, more preferentially C10-C12 diamine Xa, with at least one C4-C36, preferentially C6-C18, preferentially C6-C12, more preferentially C10-C12, diacid Yb, then said at least one diamine Xa is an aliphatic diamine and said at least one diacid Yb is an aliphatic diacid.

The diamine may be linear or branched. Advantageously, it is linear.

Said at least one C4-C36 diamine Xa may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine Xa is C5-C18 and chosen from 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one diamine Xa is C5-C12, and is chosen in particular from 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one C6 to C12 diamine Xa is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine Xa used is a C₁₀ to C₁₂ diamine, in particular chosen from 1,10-decamethylenediamine, 1,11-undecamethylenediamine and 1,12-dodecamethylenediamine.

Said at least one C4-C36 dicarboxylic acid Yb may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Yb is C6-C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Yb is C6-C12 and is chosen from adipic acid, suberic acid, azelaic acid, sebacic acid, undecanedioic acid and dodecanedioic acid.

Advantageously, said at least one dicarboxylic acid Yb is C10-C12 and is chosen from sebacic acid, undecanedioic acid and dodecanedioic acid.

When said aliphatic polyamide is obtained from the polycondensation of at least one diamine Xa with at least one dicarboxylic acid Yb, it may then comprise a single diamine or several diamines and a single dicarboxylic acid or several dicarboxylic acids.

Advantageously, said aliphatic polyamide is obtained from the polycondensation of a single diamine Xa with a single dicarboxylic acid Yb.

In one embodiment, the aliphatic polyamide a) is chosen from PA610, PA612, PA516, PA1010, PA1012, PA1014, PA1212, PA1214, PA11 and PA12.

Advantageously, it is chosen from PA612, PA516, PA1010, PA1012, PA1014, PA1212, PA1214, PA11 and PA12, in particular from PA11 and PA12.

Said at least one semiaromatic polyamide or polyphthalamide (PPA) may be a homopolyamide or a copolyamide.

When it is in the form of a homopolyamide, it has the formula XAr or Ar′Y.

XAr denotes a unit obtained from the polycondensation of a diamine X and an aromatic dicarboxylic acid Ar, the diamine X being C6-C36, preferentially C6-C18, preferentially C6-C12, more preferentially C10-C12.

The diamine may be linear or branched. Advantageously, it is linear.

Said at least one C6-C36 diamine X may be chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C6-C18 and is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is a C10 to C12 diamine, in particular chosen from 1,10-decamethylenediamine, 1,11-undecamethylenediamine and 1,12-dodecamethylenediamine.

The aromatic dicarboxylic acid is advantageously chosen from terephthalic acid (noted T), isophthalic acid (noted I), 2,5-furandicarboxylic acid and 2,6-naphthalenedicarboxylic acid (noted N) or mixtures thereof; in particular, it is chosen from terephthalic acid (noted T), isophthalic acid (noted I) or mixtures thereof.

Ar′Y denotes a unit obtained from the polycondensation of an aromatic diamine Ar′ and an aliphatic dicarboxylic acid Y, the aromatic diamine Ar′ being chosen from MXD (meta-xylylenediamine) and PXD (para-xylylenediamine), for example.

MXDY denotes a unit obtained from the polycondensation of meta-xylylenediamine (MXD) and at least one aliphatic dicarboxylic acid Y.

PXDY denotes a unit obtained from the polycondensation of para-xylylenediamine (MXD) and at least one aliphatic dicarboxylic acid Y.

Said at least one C6 to C36 dicarboxylic acid Y may be chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is a C6-C18 dicarboxylic acid and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is a C6-C12 dicarboxylic acid and is chosen from adipic acid, suberic acid, azelaic acid, sebacic acid, undecanedioic acid and dodecanedioic acid.

Advantageously, said at least one dicarboxylic acid Y is C10-C12 dicarboxylic acid and is chosen from sebacic acid, undecanedioic acid and dodecanedioic acid.

Advantageously, said polyamide a) is aliphatic.

### The Polyamide b)

Said at least one polyamide b) is as defined for polyamide a) of layer (I) except that it is a polyamide having a C/N ratio of less than 10, preferentially less than 8, and is different from that used for the polyamide of layer (I).

Advantageously, said polyamide b) is aliphatic.

In one embodiment, polyamide a) is aliphatic and is chosen from PA 410, PA510, PA610, PA412, PA512, PA612 and PA6.

Advantageously, it is chosen from PA 410, PA510, PA 612 and PA6, in particular PA6.

### The Impact Modifier c)

The impact modifier may be present at up to 30% by weight relative to the total weight of the composition of layer (I).

In one embodiment, the impact modifier is present at up to 15% by weight relative to the total weight of the composition of layer (I), in particular up to 12% by weight relative to the total weight of the composition of layer (I).

In another embodiment, the impact modifier is present at from 3% to 30% by weight relative to the total weight of the composition of layer (I), in particular from 3% to 15% by weight, notably from 3% to 12% by weight relative to the total weight of the composition of layer (I).

The impact modifier advantageously consists of a polymer with a flexural modulus of less than 100 MPa measured according to the standard ISO 178: 2010, determined at 23° C. with a relative humidity: RH of 50%, and a Tg of less than 0° C. (measured according to the standard 11357-2:2013 at the inflection point of the DSC thermogram, at a heating rate of 20 K/min), in particular a polyolefin.

The polyolefin of the impact modifier may be functionalized or non-functionalized or be a mixture of at least one which is functionalized and/or of at least one which is non-functionalized. To simplify, the polyolefin has been denoted (B) and functionalized polyolefins (B1) and non-functionalized polyolefins (B2) have been described below.

A non-functionalized polyolefin (B2) is conventionally a homopolymerorcopolymerofalpha-olefins or diolefins, for instance ethylene, propylene, 1-butene, 1-octene or butadiene. Examples that may be mentioned include:
ethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/α-olefin, such as ethylene/propylene, EPR (abbreviation for ethylene-propylene rubber) and ethylene/propylene/diene (EPDM), copolymers;
styrene/ethylene-butene/styrene (SEBS), styrene/butadiene/styrene (SBS), styrene/isoprene/styrene (SIS) or styrene/ethylene-propylene/styrene (SEPS) block copolymers;
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of α-olefins bearing reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, and the like), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01% to 5% by weight.

The functionalized polyolefin (B1) may be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin such as ethylene/propylene, EPR (abbreviation for ethylene-propylene-rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoamino polyamide (or polyamide oligomer) (products described in EP-A-0342066).

The functionalized polyolefin (B1) may also be a copolymer or terpolymer of at least the following units: (1) ethylene, (2) alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a difunctional reagent such as diacid, dianhydride, diepoxy, etc. that is capable of reacting with these polyolefins or mixtures of at least two functionalized polyolefins which can react together.

The abovementioned copolymers, (B1) and (B2), can be copolymerized in random or block fashion and may have a linear or branched structure.

The molecular weight, the MFI index and the density of these polyolefins may also vary within a broad range, which will be perceived by a person skilled in the art. MFI is the abbreviation for the Melt Flow Index. It is measured according to the standard ASTM 1238.

The non-functionalized polyolefins (B2) are advantageously chosen from polypropylene homopolymers or copolymers, and any ethylene homopolymer, or copolymer of ethylene and of a comonomer of higher alpha-olefin type, such as butene, hexene, octene, or 4-methyl-1-pentene. Mention may be made, for example, of PPs, high density PEs, medium density PEs, linear low density PEs, low density PEs or very low density PEs. These polyethylenes are known to those skilled in the art to be produced according to a “free radical” process, according to a “Ziegler” type catalysis or, more recently, according to a “metallocene” catalysis.

The functionalized polyolefins (B1) are advantageously chosen from any polymer comprising α-olefin units and units bearing polar reactive functions, such as epoxy, carboxylic acid or carboxylic acid anhydride functions. Examples of such polymers that may be mentioned include terpolymers of ethylene, of alkyl acrylate and of maleic anhydride or of glycidyl methacrylate, such as the Lotader® products (SK Functional Polymers), or polyolefins grafted with maleic anhydride, such as the Orevac® products (SK Functional Polymers), and also terpolymers of ethylene, of alkyl acrylate and of (meth)acrylic acid. Mention may also be made of polypropylene homopolymers or copolymers grafted with a carboxylic acid anhydride and then condensed with polyamides or monoamino oligomers of polyamide.

### The Additive d)

The additive may be present at up to 5% by weight relative to the total weight of the composition of layer (I).

In one embodiment, the additive is present at from 0.1% to 5% by weight relative to the total weight of the composition of layer (I).

The additives optionally used in the compositions of the invention are the conventional additives used in polyamides, well known to those skilled in the art and notably described in EP 2098580.

For example, they are chosen from catalysts, antioxidants, heat stabilizers, UV absorbers, light stabilizers, lubricants, inorganic fillers, flame retardants, nucleating agents, colorants, reinforcing fibers, waxes and mixtures thereof.

The term “catalyst” denotes a polycondensation catalyst such as a mineral or organic acid.

Advantageously, the weight proportion of catalyst is from about 50 ppm to about 5000 ppm, in particular from about 100 to about 3000 ppm, relative to the total weight of the composition.

Advantageously, the catalyst is chosen from phosphoric acid (H3PO4), phosphorous acid (H3PO3) and hypophosphorous acid (H3PO2), or a mixture thereof.

By way of example, the stabilizer may be a UV stabilizer, an organic stabilizer or more generally a combination of organic stabilizers, such as an antioxidant of phenol type (for example of the type such as Irganox® 245 or 1098 or 1010 from the company Ciba-BASF), an antioxidant of phosphite type (for example Irgafos® 126 and Irgafos® 168 from the company Ciba-BASF) and even optionally other stabilizers, such as a HALS, which means Hindered-Amine Light Stabilizer (for example Tinuvin® 770 from the company Ciba-BASF), a UV stabilizer (for example Tinuvin® 312 from the company Ciba), or a phosphorus-based stabilizer. Use may also be made of antioxidants of amine type, such as Naugard® 445 from the company Crompton or else polyfunctional stabilizers, such as Nylostab® S-EED from the company Clariant.

This stabilizer may also be a mineral stabilizer, such as a copper-based stabilizer. Examples of such mineral stabilizers that may be mentioned include copper acetates and halides. Incidentally, other metals, such as silver, may possibly be considered, but said metals are known to be less effective. These copper-based compounds are typically combined with halides of alkali metals, in particular of potassium.

The mineral fillers are, for example, antistatic fillers chosen, for example, from carbon black, graphite, carbon fibers and carbon nanotubes, in particular carbon black and carbon nanotubes.

### The Plasticizer e)

The plasticizer may be present at from 0 to 14% by weight relative to the total weight of the composition of layer (I).

By way of example, the plasticizers are chosen from benzenesulfonamide derivatives, such as n-butylbenzenesulfonamide (BBSA); ethyltoluenesulfonamide or N-cyclohexyltoluenesulfonamide; hydroxybenzoic acid esters such as 2-ethylhexyl para-hydroxybenzoate and 2-hexyldecyl para-hydroxybenzoate; tetrahydrofurfuryl alcohol esters or ethers such as oligoethyleneoxytetrahydrofurfuryl alcohol; and esters of citric acid or of hydroxymalonic acid, such as oligoethyleneoxy malonate.

It would not constitute a departure from the scope of the invention to use a mixture of plasticizers.

In one embodiment, the plasticizer is present in the composition at from 1% to 14% by weight, in particular from 1% to 12% by weight, relative to the total weight of the composition of layer (I).

In another embodiment, the plasticizer is present at from 5% to 14% by weight, in particular from 5% to 12% by weight, relative to the total weight of the composition of layer (I).

In one embodiment, said composition of said outer layer (I) consists of:
a) from 41% to 100% by weight of at least one polyamide, in particular an aliphatic polyamide, having a C/N ratio of greater than 7, preferentially greater than 8,
b) from 0 to 10% by weight of at least one aliphatic polyamide different from the preceding one, having a C/N ratio of less than 10, preferentially less than 8,
c) from 0 to 30% by weight of at least one impact modifier,
d) from 0 to 5% by weight of at least one additive,
e) from 0 to 14% by weight of at least one plasticizer,
the sum of the constituents a)+b)+c)+d)+e) being equal to 100% by weight.

### As Regards Layer (II)

Layer (II) is a barrier layer that is water-soluble at a temperature of less than or equal to 150° C., in particular less than or equal to 120° C.

The term “barrier” layer means that the layer has a very low permeability to transported fluids.

The term “barrier layer” refers to a layer with very little permeability to fluids, notably to fuels, in particular to alcohol-blended gasoline and hydrogen, which consequently allows very little fluid, in particular fuel, notably gasoline, in particular alcohol-blended gasoline, to pass into the atmosphere or hydrogen.

In particular, the term “barrier layer” means that the proportion of fuel, notably gasoline, in particular alcohol-blended gasoline, which passes into the atmosphere is less than 150 g·mm/m²·day, notably less than 20 g·mm/m²·day as determined with a CE 10 fuel at 60° C.

The measurements of permeability to gasolines are determined at 60° C. according to a gravimetric method with CE10: isooctane/toluene/ethanol=45/45/10 vol % and CE85: isooctane/toluene/ethanol=7.5/7.5/85 vol % on plaques consisting of a polymer material.

In particular, the term “barrier layer” means that said layer is leaktight to hydrogen at 23° C., i.e. the permeability to hydrogen at 23° C. is less than 500 cc·mm/m²·24 h·atm at 23° C. under 0% relative humidity (RH). The instantaneous permeability is zero during the induction period, then it gradually increases up to an equilibrium value which corresponds to the permeability value under continuous operating conditions. This value, obtained under continuous operating conditions, is considered to be the permeability of the material.

The term “water-soluble at a temperature of less than or equal to 150° C., in particular less than or equal to 120° C.” means that the polymer in layer (II) below this temperature is water-soluble and notably has a water solubility of greater than 2%, for example ranging from 2% to 100% (mass percentage of polymer in water) at or below this temperature.

Ethylene-vinyl alcohol (EVOH) is not a water-soluble polymer within the meaning of the invention.

In one embodiment, the water solubility of said water-soluble polymer is from 5% to 20%, in particular from 10% to 20% at a temperature of from 35° C. to 150° C., notably from 35° C. to 120° C., in particular from 70° C. to 150° C., notably from 70° C. to 120° C.

The aqueous solution for dissolving layer (II) may have a pH other than 7, advantageously between 1 and 12, preferably between 3 and 9.

The water-soluble polymers may be:
natural polymers such as: dextrin, casein, dextran, pullulan or based on these elements,
artificial polymers: cellulose ethers;
synthetic polymers: vinyl: polyvinyl alcohol (PVAL), polyacrylamide.

In another embodiment, the water-soluble polymer is chosen from copolymers comprising the vinyl alcohol and/or vinyl acetate unit in a content of greater than 50% w/w, for example greater than 70% w/w, preferentially greater than 80% w/w, and a milk casein-based polymer.

In a first variant of this embodiment, said water-soluble polymer is a copolymer comprising at least (i) a vinyl alcohol unit in a content of greater than or equal to 50% by weight, relative to the total weight of said copolymer and (ii) an olefin unit comprising at least one heteroatom in a content of less than or equal to 50% by weight, relative to the total weight of said copolymer.

According to this embodiment, the term “olefin unit comprising at least one heteroatom” means an olefin unit other than the vinyl alcohol unit.

According to this embodiment, said water-soluble polymer is thus a copolymer comprising at least (i) a vinyl alcohol unit in a content of greater than or equal to 50% by weight, relative to the total weight of said copolymer, and (ii) an olefin unit comprising at least one heteroatom in a content of less than or equal to 50% by weight, relative to the total weight of said copolymer, with said olefin unit comprising at least one heteroatom being other than said vinyl alcohol unit.

The term “heteroatom” is intended to denote an atom other than the carbon atom (C) and the hydrogen atom (H). It may notably be a nitrogen atom (N) or an oxygen atom (0).

The olefin unit comprising at least one heteroatom may be an olefin unit comprising at least one nitrogen and/or oxygen atom.

According to one embodiment, the term “olefin unit comprising at least one heteroatom” means an olefin unit other than the vinyl acetate unit.

It may notably be an olefin unit comprising at least one, or even several, alcohol (—OH), amine (—NH2) or carboxylic acid (—COOH) functions.

According to one embodiment, the olefin unit comprising at least one heteroatom for the purposes of the invention typically comprises carbon atoms and heteroatoms in a ratio [Number of carbon atoms]/[Number of heteroatoms] of between 1 and 10, for example between 1.5 and 8, for example greater than 2, for example between 2 and 6.

According to one embodiment, it may be an olefin unit comprising at least one alcohol function, said unit being other than vinyl alcohol. It may notably be an olefin unit comprising at least two alcohol functions. By way of example, mention may be made of units derived from an alkenediol, for instance propenediol units.

According to another embodiment, it may be an olefin unit comprising at least one amine function, notably at least two amine functions, for instance butenediamine units.

According to another embodiment, it may be an olefin unit comprising at least one carboxylic acid function, notably at least two carboxylic acid functions.

According to another embodiment, it may be an olefin unit comprising at least one alcohol function and at least one amine function.

According to one embodiment, it may be an olefin unit comprising at least one alcohol function and at least one carboxylic acid function.

According to one embodiment, it may be an olefin unit comprising at least one amine function and at least one carboxylic acid function.

According to one embodiment, said water-soluble polymer is thus a copolymer comprising at least (i) a vinyl alcohol unit in a content of greater than or equal to 50% by weight, relative to the total weight of said copolymer, and (ii) an olefin unit comprising at least one heteroatom chosen from nitrogen and oxygen in a content of less than or equal to 50% by weight, relative to the total weight of said copolymer, with said olefin unit comprising at least one heteroatom being other than said vinyl alcohol unit and a vinyl acetate unit.

According to any one of the embodiments of this first variant, said copolymer may comprise said vinyl alcohol unit in a content of greater than or equal to 70% by weight, advantageously greater than or equal to 85% by weight, relative to the total weight of said copolymer.

According to any of the embodiments of this first variant, said copolymer may comprise said olefin unit comprising at least one heteroatom, for example as defined previously, in a content of less than or equal to 30% by weight, advantageously less than or equal to 15% by weight, relative to the total weight of said copolymer.

According to any one of the embodiments, said water-soluble polymer may be a copolymer comprising at least one other unit.

It may notably be a copolymer comprising at least (i) a vinyl alcohol unit in a content of greater than or equal to 50% by weight, relative to the total weight of said copolymer, (ii) an olefin unit comprising at least one heteroatom as defined previously, with said olefin unit comprising at least one heteroatom being different from said vinyl alcohol unit and a vinyl acetate unit, and (iii) a vinyl acetate unit, with said olefin unit comprising at least one heteroatom and said vinyl acetate unit being present together in a content of less than or equal to 50% by weight, relative to the total weight of said copolymer.

Preferably, according to this embodiment, said vinyl acetate unit may be present in a content of less than or equal to 20% by weight, for example less than or equal to 15% by weight, for example less than or equal to 10% by weight, for example less than or equal to 5% by weight, typically less than or equal to 1% by weight, relative to the total weight of said copolymer.

According to any one of the embodiments of this first variant, said water-soluble polymer comprises less than 10% by weight of olefin units of formula CnH2n, relative to the total weight of said copolymer.

In particular, it may comprise less than 5% by weight, notably less than 1% by weight, of olefin units of formula CnH2n, relative to the total weight of said copolymer.

According to one embodiment, the water-soluble copolymer is free of olefin units of formula CnH2n.

The term “olefin of formula CnH2n” is intended to denote an olefin comprising only carbon and hydrogen atoms.

According to another embodiment, said water-soluble polymer may be a copolymer consisting of (i) a vinyl alcohol unit in a content of greater than or equal to 50% by weight, relative to the total weight of said copolymer and (ii) an olefin unit comprising at least one heteroatom, for example chosen from nitrogen and oxygen, in a content of less than or equal to 50% by weight, relative to the total weight of said copolymer, with said olefin unit comprising at least one heteroatom being other than said vinyl alcohol unit.

In a second variant of this embodiment (i.e. of the embodiment described previously according to which the water-soluble polymer is chosen from copolymers comprising the vinyl alcohol and/or vinyl acetate unit in a content of greater than 50% w/w, for example greater than 70% w/w, preferentially greater than 80% w/w and a milk casein-based polymer), said water-soluble polymer is a copolymer comprising at least one vinyl alcohol unit in a content of greater than or equal to 50% by weight and a vinyl acetate unit in a content of less than or equal to 50% by weight, relative to the total weight of said copolymer.

According to any one of the embodiments of this second variant, said copolymer may comprise said vinyl alcohol unit in a content of greater than or equal to 70% by weight, for example greater than or equal to 80% by weight, for example greater than or equal to 90% by weight, for example greater than or equal to 95% by weight, relative to the total weight of said copolymer.

According to any one of the embodiments of this second variant, said copolymer may comprise said vinyl acetate unit in a content of less than or equal to 30% by weight, for example less than or equal to 20% by weight, for example less than or equal to 10% by weight, for example less than or equal to 5% by weight, relative to the total weight of said copolymer.

According to any one of the embodiments of this second variant, said water-soluble polymer may be a copolymer comprising at least one other unit.

According to any one of the embodiments of this second variant, said water-soluble polymer comprises less than 10% by weight of olefin units of formula CnH2n, relative to the total weight of said copolymer.

In particular, it may comprise less than 5% by weight, notably less than 1% by weight, of olefin units of formula CnH2n, relative to the total weight of said copolymer.

According to one embodiment, the water-soluble copolymer is free of olefin units of formula CnH2n.

The term “olefin of formula CnH2n” is intended to denote an olefin comprising only carbon and hydrogen atoms.

According to another embodiment, said water-soluble polymer may be a copolymer consisting of (i) a vinyl alcohol unit in a content of greater than or equal to 50% by weight and (ii) a vinyl acetate unit in a content of less than or equal to 50% by weight.

The presence of heteroatoms or the ratios may be determined by carbon NMR in DMSO-d6.

In one other embodiment, the melting point (Tm) of the water-soluble polymer is from 160° C. to 250° C., in particular from 165° C. to 220° C.

In one embodiment, layer (II) comprises from 0.1% to 30% by weight of glycerol, advantageously from 1% to 13.5% by weight, relative to the total weight of said layer (II).

In one embodiment, the water-soluble polymer comprises functions that can react with polyamides, notably carboxylic acid and primary amine functions.

Tg, Tc and Tm are determined by differential scanning calorimetry (DSC) according to the standards 11357-2:2013 and 11357-3:2013, respectively.

In yet another embodiment, the transformation temperature of the water-soluble polymer is from 180° C. to 250° C., in particular from 190° C. to 220° C.

According to one embodiment, the present invention relates to a process for manufacturing a multilayer structure as defined according to the invention, comprising at least one step of extruding or injecting said water-soluble polymer at a temperature of from 180° C. to 250° C., in particular from 190° C. to 220° C.

In one embodiment, the water-soluble polymer of layer (II) excludes ethylene-vinyl alcohol (EVOH).

According to one embodiment, the water-soluble polymer of layer (II) is other than an ethylene-vinyl alcohol (EVOH).

In particular, it is known practice that ethylene-vinyl alcohol (EVOH) is generally transformed, typically extruded or injected, at temperatures below 180° C.

### As Regards the Inner Layer

The inner layer is either a layer (III) of polyamide, in particular of aliphatic polyamide, or a layer (IV) predominantly comprising at least one polyamide.

In these two cases, said layer (III) or (IV) is then the layer that is in contact with the fluid being transported.

The inner layer may also be a layer (IV) adjacent to a layer (III). In the latter case, layer (IV) is also adjacent to layer (II) and layer (III) is then the innermost layer. Layer (III) in the latter case is then the layer that is in contact with the fluid being transported.

As Regards the Composition of the Inner Layer (III) when it is Present

Said composition of the inner layer (III) comprises:
a) from 41% to 100% by weight of at least one polyamide, in particular an aliphatic polyamide, having a C/N ratio of greater than 7, preferentially greater than 8,
b) from 0 to 10% by weight of at least one aliphatic polyamide different from the preceding one, having a C/N ratio of less than 10, preferentially less than 8,
c) from 0 to 30% by weight of at least one impact modifier,
d) from 0 to 5% by weight of at least one additive,
e) from 0 to 14% by weight of at least one plasticizer, the sum of the constituents a)+b)+c)+d)+e) being equal to 100% by weight.

The constituents a), b), c), d) and e) are as defined for the composition of layer (I).

Each constituent a), b), c), d) and e) of the composition of the inner layer (III) may be identical to or different from that of layer (I).

In one embodiment, said composition of the inner layer (III) consists of:
a) from 41% to 100% by weight of at least one polyamide, in particular an aliphatic polyamide, having a C/N ratio of greater than 7, preferentially greater than 8,
b) from 0 to 10% by weight of at least one polyamide, in particular an aliphatic polyamide different from the preceding one, having a C/N ratio of less than 10, preferentially less than 8,
c) from 0 to 30% by weight of at least one impact modifier,
d) from 0 to 5% by weight of at least one additive,
e) from 0 to 14% by weight of at least one plasticizer,
the sum of the constituents a)+b)+c)+d)+e) being equal to 100% by weight.

In one embodiment, the plasticizer is excluded from the composition of the inner layer (III) when it is present.

As Regards the Composition of the Inner Layer (IV) when it is Present

It predominantly comprises at least one polyamide of aliphatic type or consisting of more than 75% of aliphatic units, said aliphatic polyamide being chosen from:
a polyamide, denoted A, with a mean number of carbon atoms per nitrogen atom, denoted CA, of from 4 to 8.5, advantageously from 4 to 7;
a polyamide, denoted B, with a mean number of carbon atoms per nitrogen atom, denoted CB, of from 7 to 10, advantageously from 7.5 to 9.5;
a polyamide, denoted C, with a mean number of carbon atoms per nitrogen atom, denoted CC, of from 9 to 18, advantageously from 10 to 18.

The aliphatic polyamides noted A, B and C are as defined for the aliphatic polyamide of the outer layer (I) on condition that the average number of carbon atoms per nitrogen atom for each is respected.

In one embodiment, said composition of layer (IV) consists predominantly of at least one polyamide of aliphatic type or consisting of more than 75% aliphatic units, said aliphatic polyamide being chosen from:
a polyamide, denoted A, with a mean number of carbon atoms per nitrogen atom, denoted CA, of from 4 to 8.5, advantageously from 4 to 7;
a polyamide, denoted B, with a mean number of carbon atoms per nitrogen atom, denoted CB, of from 7 to 10, advantageously from 7.5 to 9.5;
a polyamide, denoted C, with a mean number of carbon atoms per nitrogen atom, denoted CC, of from 9 to 18, advantageously from 10 to 18.

In one embodiment, the plasticizer is excluded from the composition of the inner layer (IV) when it is present.

In one embodiment, the plasticizer is excluded from the composition of the inner layer (III) and of the outer layer (IV) when they are present.

### As Regards the Structure Perse

Said structure comprises at least three layers, from the outside inward:
(I)//(II)//(III) or (I)//(II)//(IV)

In one embodiment, said structure further comprises a layer (V) between layer (I) and layer (II), said layer (V) consisting of a composition predominantly comprising at least one polyamide of aliphatic type or consisting of more than 75% aliphatic units, said aliphatic polyamide being chosen from:
a polyamide, denoted A, with a mean number of carbon atoms per nitrogen atom, denoted CA, of from 4 to 8.5, advantageously from 4 to 7;
a polyamide, denoted B, with a mean number of carbon atoms per nitrogen atom, denoted CB, of from 7 to 10, advantageously from 7.5 to 9.5;
a polyamide, denoted C, with a mean number of carbon atoms per nitrogen atom, denoted CC, of from 9 to 18, advantageously from 10 to 18.

Said at least one polyamide of aliphatic type of said composition of layer (V) is as defined for said polyamide of aliphatic type of said composition of layer (IV).

Said structure may thus comprise at least four layers when layers (III) and (IV) are present from the outside inward:
(I)//(II)//(IV)//(III)
   or when layer (V) is present from the outside inward:
(I)//(V)//(II)//(III) or (I)//(V)//(II)//(IV)

Said structure may also comprise at least five layers when layers (III) and (IV) are present and when layer (V) is present from the outside inward:
(I)//(V)//(II)//(IV)//(III)

In a first variant, said structure consists of three layers from the outside inward:
(I)//(II)//(III) or (I)//(II)//(IV)

In a second variant, said structure consists of four layers from the outside inward:
(I)//(II)//(IV)//(III) or (I)//(V)//(II)//(III) or (I)//(V)//(II)//(IV)

In a third variant, said structure consists of five layers from the outside inward:
(I)//(V)//(II)//(IV)//(III)

Irrespective of the above embodiments or variants, the thickness of layer (II) in said structure is from 5% to 30%, preferentially from 6% to 20%, of the sum of the thicknesses of each layer.

Advantageously, said structure is chosen from a tank, a hose and a tube.

In one embodiment, the proportion of extractables as determined by a test which consists in filling a tubular structure with alcohol-blended gasoline of the FAM-B type and heating the assembly at 60° C. for 96 hours, then emptying it by filtering it into a beaker, is a maximum of 1 g/m² and in particular 0.8 of insoluble extract.

Advantageously, the filtrate from the beaker is then allowed to evaporate at room temperature to weigh this residue, the proportion of which must be less than or equal to about 8 g/m², in particular 6 g/m² of internal tube surface area.

The alcohol-blended gasoline FAM B is described in the standards DIN 51604-1: 1982, DIN 51604-2: 1984 and DIN 51604-3: 1984.

Briefly, alcohol-blended gasoline FAM A is first prepared with a mixture of 50% of toluene, 30% of isooctane, 15% of diisobutylene and 5% of ethanol then FAM B is prepared by mixing 84.5% of FAM A with 15% of methanol and 0.5% of water.

FAM B consists in total of 42.3% of toluene, 25.4% of isooctane, 12.7% of diisobutylene, 4.2% of ethanol, 15% of methanol and 0.5% of water.

According to another aspect, the present invention relates to a composition comprising at least 30%, advantageously 50% by weight relative to the total weight of the composition, of a multilayer structure as defined above, after recycling by grinding and partial or total dissolution of said water-soluble polymer by washing said ground structure with hot water.

In one embodiment, said composition comprises less than 5% by weight, advantageously 1% by weight, of said water-soluble polymer relative to the total weight of said composition after grinding and washing with hot water.

In one embodiment, the polyamide of said composition comprises functions derived from oxidation reactions or reactions with motor vehicle fluids.

The polyamide comprising functions derived from oxidation reactions or reactions with motor vehicle fluids may originate either from the outer layer (I) or from the inner layers (III) and/or (IV).

During the use, in motor vehicles, of tubes for the transportation or the storage of fluids, new species resulting from oxidation mechanisms, notably amide functions and/or methylene in the alpha position relative to said amide functions, such as imide, carboxylic acid, primary amide and alcohol functions, appear in the polyamides constituting said tubes or tanks.

Said functions appear as a result of UV radiation or heat, or as a result of a reaction with a compound with which said subject is in contact, for example gasoline, antisun cream, lubricants, etc.

Said functions may be detected by infrared spectrometry.

Thus, the absorption band from 1700 to 1740 cm⁻¹ corresponds to an imide, that from 1680 to 1720 cm⁻¹ to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized firstly by a pair of absorption bands from 3100 to 3500 cm⁻¹ and from 1560 to 1640 cm⁻¹ which corresponds to the NH group of the amide, and secondly by the absorption band from 1650 to 1700 cm⁻¹ which corresponds to the carbonyl group of the amide.

In one embodiment, said polyamide of said monolayer and/or multilayer tube having been intended for the transportation of motor vehicle fluids, or also used tube, bears functions resulting from oxidation reactions, chosen from imide, carboxylic acid and alcohol functions and mixtures thereof, in a mole ratio, relative to the amide functions, which is greater than that of the same polyamide constituting an unused tube which has never yet transported motor vehicle fluids.

Advantageously, said mole ratio of the functions resulting from oxidation reactions relative to the secondary amide functions is from 1/10 000 to 1/20.

The concentrations may be measured by proton NMR in dichloromethane-d2, with the addition of HFIP (hexafluoroisopropanol) to dissolve the polyamide.

In a first variant, said mole ratio of imide functions is from 1/1000 to 1/20, notably from 1/500 to 1/20, in particular from 1/200 to 1/50.

In a second variant, said mole ratio of carboxylic acid functions is from 1/5000 to 1/20, notably from 1/3000 to 1/50, very advantageously from 1/500 to 1/15.

In a third variant, said mole ratio of alcohol functions is from 1/1000 to 1/20, advantageously from 1/1000 to 1/25 and very advantageously from 1/200 to 1/50.

In a fourth variant, said mole ratio of primary amide functions relative to the secondary amide functions is from 1/2000 to 1/20, advantageously from 1/1000 to 1/100 and very advantageously from 1/1000 to 1/500.

In a fifth variant, said mole ratio of nitrile functions relative to the secondary amide functions is from 1/1000 to 1/20, advantageously from 1/500 to 1/15 and very advantageously from 1/100 to 1/10.

In a sixth variant, said mole ratio of chain-end methyl functions relative to the secondary amide functions is from 1/5000 to 1/50, advantageously from 1/2000 to 1/100 and very advantageously from 1/1000 to 1/200.

It is quite obvious that as a function of the single-layer and/or multilayer tubes having been intended for transporting motor vehicle fluids, or even used tubes, and of the exposure to which they will have been subjected, one or more functions resulting from oxidizing reactions may be present.

The composition also advantageously comprises residues of stabilizers chosen from phenols, quinones, stilbenequinones and phosphite.

The recycled polyamide advantageously comprises alkyl chain ends with a carbon number (between 1 and 18) which is greater than that of a virgin PA. Advantageously, the alkyl chain end content is between 1 ppm and 0.5%.

The used polyamide of said composition is more crystalline than virgin polyamide.

The percentage of crystallization can be measured by DSC (or by X-ray).

Advantageously, the used polyamide has a degree of crystallinity greater by at least 2%, in particular by at least 5%, than that of a virgin polyamide, as measured by DSC.

According to another aspect, the present invention relates to a process for recycling a structure as defined above, characterized in that it comprises a step of grinding said structure and then washing it with hot water so as to dissolve and at least partially remove the water-soluble polymer from said structure in order to obtain the other constituents of said structure.

The temperature of the hot water is from 70° C. to 150° C., in particular from 70° C. to 120° C.

The hot water may have a pH of between 1 and 12.

In one embodiment, said process comprises a step of extrusion or injection of the other constituents of said structure.

In one embodiment, said process comprises a compounding step prior to the extrusion or injection.

This compounding step allows the addition of an impact modifier and/or an additive and/or a plasticizer.

In another embodiment, said injection or extrusion step allows the production of another tank, hose or tube.

### EXAMPLES

The invention will now be described in greater detail by means of the following examples, which are not limiting.

The following structures were prepared by extrusion:

The multilayer tubes are produced by coextrusion. A McNeil industrial multilayer extrusion line is used, equipped with five extruders connected to a multilayer extrusion head with spiral mandrels.

The screws used are single extrusion screws having screw profiles suited to polyamides. In addition to the five extruders and the multilayer extrusion head, the extrusion line includes:
a die-punch assembly, located at the end of the coextrusion head; the inside diameter of the die and the outside diameter of the punch are chosen as a function of the structure to be made and of the materials of which it is composed, and also as a function of the dimensions of the tube and the line speed;
a vacuum tank with an adjustable level of vacuum. Water maintained in general at 20° C. circulates in this tank, into which water is immersed a gauge for conforming the tube into its final dimensions. The diameter of the gauge is adapted to the dimensions of the tube to be made, typically from 8.5 to 10 mm for a tube with an outside diameter of 8 mm and a thickness of 1 mm;
a succession of cooling tanks in which water is maintained at about 20° C., for cooling the tube along the path from the head to the drawing bench;
a diameter measurer;
a drawing bench.

The configuration with five extruders is used to make tubes ranging from two layers to five layers. In the case of the structures in which the number of layers is less than five, several extruders are then fed with the same material.

In the case of structures including six layers, an additional extruder is connected and a spiral mandrel is added to the existing head, with a view to producing the inner layer in contact with the fluid.

Before the tests, in order to ensure the best properties for the tube and a good extrusion quality, it is verified that the extruded materials have a residual moisture content before extrusion of less than 0.08%. If this is not the case, an additional step of drying the material before the tests is performed, generally in a vacuum dryer, overnight at 80° C.

The tubes, which meet the characteristics described in the present patent application, were taken, after stabilization of the extrusion parameters, the target dimensions of the tube no longer changing over time. The diameter is monitored by a laser diameter measurer installed at the end of the line.

The line speed is 20 m/min.

The speed of the extruder screws depends on the thickness of the layer and on the screw diameter, as is known to those skilled in the art.

In general, the temperatures of the extruders and tools (head and joint) should be set so as to be sufficiently higher than the melting point of the compositions under consideration, such that they remain in the molten state, thus preventing them from solidifying and blocking the machine.

The tubular structures prepared (Table 1) were tested as regards the recyclability parameter (Table 2) according to the following protocol:

The extruded structures were placed in contact with CE85 gasoline at 60° C. for 500 hours, so as to simulate a gasoline line application. After this conditioning, they were ground and washed in water at 85° C. for 5 hours, with a mass ratio of ground material to water of 50%.

The extruded structures were also placed in contact with hydrogen at 23° C./0% RH for 168 hours, so as to simulate a storage application. After this conditioning, they were ground and washed in water at 85° C. for 5 hours, with a mass ratio of ground material to water of 50%.

After this conditioning, they were ground and washed in water at 85° C. for 5 hours, with a mass ratio of ground material to water of 50%.

The results obtained after exposure to gasoline and hydrogen are identical. A single mass loss value (weight %) is reported in Table 2.

The CE85 gasoline and hydrogen permeability measurements were taken according to the following protocols:

The gasoline permeability measurement consists in placing CE85 gasoline in a structure, and then hermetically closing the assembly. This assembly is then placed in an ATEX chamber regulated at 60° C. Periodic weighing enables the amount of gasoline vapor diffusing through the structure to be determined. A weight loss curve is plotted as a function of time for a 500-hour test, and the permeability coefficient is determined from the slope of the weight loss curve and the surface area of the sample (Protocol 1).

The hydrogen stream at 23° C. and 0% RH is determined according to the standard ISO 15105-2 (Protocol 2).

The qualification of good recyclability was evaluated gravimetrically by estimating the mass loss of ground material before and after washing. This mass loss was attributed predominantly to the water-soluble polymer.

| Exam- | | | | |
|---|---|---|---|---|
| ples | Structures | | | |
| CE1 | PA11^{a}/EVOH/PA11^{a} (425/150/425) | | | |
| EI 1 | PA11^{a}/PVOH*/PA11^{a} (425/150/425) | | | |
| CE2 | PA11^{a}/Tieflex/EVOH/Tieflex (150/350/100/400) | | | |
| EI2 | PA11^{a}/Tieflex/PVOH*/Tieflex (150/350/100/400) | | | |
| CE3 | PA11^{a}/Tieflex/EVOH/Tieflex/PA11^{a} | | | |
| | (150/400/150/150/150) | | | |
| EI 3 | PA11^{a}/Tieflex/PVOH*/Tieflex/PA11^{a} | | | |
| | (150/400/150/150/150) | | | |
| EI 4 | PA11^{a}/Tieflex/PVOH **/Tieflex/PA11^{a} | | | |
| | (150/400/150/150/150) | | | |
| EI 5 | PA11^{b}/PVOH*/PA11^{b} (425/150/425) | | | |
| EI 6 | PA12/PVOH*/PA12 (425/150/425) | | | |
| EI 7 | PA11^{a}/PPVOH/PA11^{a} (425/150/425) | | | |
| Exam- | | | g · mm/ | cm³ · mm/ |
| ples | Recyclability | % | m² · day | m² · day |
| CE1 | Poor | ≤5 | 25 | 7 |
| El 1 | Good | >5 | 3 | <5 |
| CE2 | Poor | ≤5 | 40 | 10 |
| EI2 | Good | >5 | 12 | <5 |
| CE3 | Poor | ≤5 | 25 | 7 |
| EI 3 | Good | >5 | 8 | <5 |
| EI 4 | Good | >5 | 110 | <5 |
| EI 5 | Good | >5 | 3 | <5 |
| EI 6 | Good | >5 | 3 | <5 |
| EI 7 | Good | >5 | 10 | <5 |

CE1 to 3: counter-examples
EI1 to 7: Examples of the invention
The values in brackets in Table 1 correspond to the thickness (in um) of each layer. The densities are close to 1.
EVOH: LA107B grade from Kuraray
PVOH*: Mowiflex H15 grade from Kuraray, comprising 97% by weight of vinyl alcohol units
PVOH**: Mowiflex C30 grade from Kuraray, comprising 79% by weight of vinyl alcohol units
PPVOH: copolymer comprising 90% by weight of vinyl alcohol units and 10% by weight of propenediol units
Tieflex: composition comprising 80% by weight of PA 6 Ultramid B40 (BASF), 5% by weight of PA 610 with an Mn of 27 000 g/mol, 5% by weight of PA 11 with an Mn of 25 000 g/mol and 10% by weight of Orevac IM 800 impact modifier (SK Functional Polymers)
PA11^{a}: PA 11 with an Mn of 25 000 g/mol and comprising 10% by weight of Orevac IM 800 impact modifier (SK Functional Polymers)
PA11^{b}: PA 11 with an Mn of 25 000 g/mol
PA12: PA 12 with an Mn of 25 000 g/mol and comprising 10% Orevac IM 800 impact modifier (SK Functional Polymers)

Protocols 1 and 2 defined in Table 2 correspond to the experimental conditions of the permeation tests.

Protocol 1: CE85 gasoline at 60° C. for 500 hours

Protocol 2: Hydrogen at 23° C. for 168 hours. A mass loss of over 5% (of total tube mass) means that at least a third (30% by weight) of the barrier layer has dissolved during recycling, and thus that the recycled polyamide will be of higher quality.

1. A recyclable multilayer structure for the transport, distribution or storage of fluids, comprising from the outside inward:
1) an outer layer (I) made of polyamide, comprising a composition comprising:
a) from 41% to 100% by weight of at least one polyamide, having a C/N ratio of greater than 7,
b) from 0 to 10% of at least one polyamide, having a C/N ratio of less than 10,
c) from 0 to 30% by weight of at least one impact modifier,
d) from 0 to 5% by weight of at least one additive,
e) from 0 to 14% by weight of at least one plasticizer,
the sum of the constituents a)+b)+c)+d)+e) being equal to 100% by weight,
2) a barrier layer (II) that is water-soluble at a temperature of less than or equal to 150° C.,
3) an inner layer:
(III) made of polyamide, comprising a composition comprising:
a) from 41% to 100% by weight of at least one aliphatic polyamide having a C/N ratio of greater than 7,
b) from 0 to 10% by weight of at least one polyamide, having a C/N ratio of less than 10,
c) from 0 to 30% by weight of at least one impact modifier,
d) from 0 to 5% by weight of at least one additive,
e) from 0 to 14% by weight of at least one plasticizer,
the sum of the constituents a)+b)+c)+d)+e) being equal to 100% by weight,
and/or
(IV) predominantly comprising at least one polyamide of aliphatic type or consisting of more than 75% of aliphatic units, said aliphatic polyamide being chosen from:
a polyamide, denoted A, with a mean number of carbon atoms per nitrogen atom, denoted CA, of from 4 to 8.5,
a polyamide, denoted B, with a mean number of carbon atoms per nitrogen atom, denoted CB, of from 7 to 10,
a polyamide, denoted C, with a mean number of carbon atoms per nitrogen atom, denoted CC, of from 9 to 18,
layer (IV) being adjacent to layer (II) if layer (III) is also present, and layer (III) then being the innermost, or layer (IV) being the innermost if layer (III) is absent.

2. The recyclable multilayer structure as claimed in claim 1, wherein said barrier layer (II) which is water-soluble at a temperature of less than or equal to 150° C., is made of a water-soluble polymer chosen from copolymers comprising the vinyl alcohol and/or vinyl acetate unit in a content of greater than 50% w/w, and a milk casein-based polymer.

3. The recyclable multilayer structure as claimed in claim 1, wherein the water-soluble polymer is a copolymer comprising at least (i) a vinyl alcohol unit in a content of greater than or equal to 50% by weight, relative to the total weight of said copolymer, and (ii) an olefin unit comprising at least one heteroatom in a content of less than or equal to 50% by weight, relative to the total weight of said copolymer.

4. The recyclable multilayer structure as claimed claim 3, wherein said copolymer comprises said vinyl alcohol unit in a content of greater than or equal to 70% by weight, relative to the total weight of said copolymer.

5. The recyclable multilayer structure as claimed in claim 3, wherein said copolymer comprises said olefin unit comprising at least one heteroatom in a content of less than or equal to 30% by weight, relative to the total weight of said copolymer.

6. The recyclable multilayer structure as claimed in claim 1, wherein the water-soluble polymer is a copolymer comprising at least one vinyl alcohol unit in a content of greater than or equal to 50% by weight, and one vinyl acetate unit in a content of less than or equal to 50% by weight, relative to the total weight of said copolymer.

7. The recyclable multilayer structure as claimed in claim 6, wherein the water-soluble polymer comprises said vinyl alcohol unit in a content of greater than or equal to 70% by weight, relative to the total weight of said copolymer.

8. The recyclable multilayer structure as claimed in claim 6, wherein the water-soluble polymer comprises said vinyl acetate unit in a content of less than or equal to 30% by weight, relative to the total weight of said copolymer.

9. The recyclable multilayer structure as claimed in claim 1, wherein the melting point of the water-soluble polymer is from 160° C. to 250° C.

10. The recyclable multilayer structure as claimed in claim 1, wherein the transformation temperature of the water-soluble polymer is from 180° C. to 250° C.

11. The recyclable multilayer structure as claimed in claim 1, wherein the water solubility of said water-soluble polymer is from 5% to 20% at a temperature of from 35° C. to 150° C.

12. The recyclable multilayer structure as claimed in claim 1, wherein a layer (V) is present between layer (I) and layer (II), said layer (V) consisting of a composition predominantly comprising at least one polyamide of aliphatic type or consisting of more than 75% aliphatic units, said aliphatic polyamide being chosen from:
a polyamide, denoted A, with a mean number of carbon atoms per nitrogen atom, denoted CA, of from 4 to 8.5;
a polyamide, denoted B, with a mean number of carbon atoms per nitrogen atom, denoted CB, of from 7 to 10;
a polyamide, denoted C, with a mean number of carbon atoms per nitrogen atom, denoted CC, of from 9 to 18.

13. The recyclable multilayer structure as claimed in claim 1, wherein it comprises three layers from the outside inward:
(I)//(II)//(III) or (I)//(II)//(IV)

14. The recyclable multilayer structure as claimed in claim 12, wherein it comprises four layers from the outside inward:
(I)//(V)//(II)//(III) or (I)//(V)//(II)//(IV)

15. The recyclable multilayer structure as claimed in claim 12, wherein it comprises five layers from the outside inward:
(I)//(V)//(II)//(IV)//(II)

16. The recyclable multilayer structure as claimed in claim 1, wherein the thickness of layer (II) in the structure is from 5% to 30% of the sum of the thicknesses of each layer.

17. The recyclable multilayer structure as claimed in claim 1, wherein it is chosen from a tank, a hose and a tube.

18. A composition comprising at least 30% by weight, relative to the total weight of the composition, of a multilayer structure as defined in claim 1, after recycling by grinding and partial or total dissolution of the water-soluble polymer by washing said ground structure with hot water.

19. The composition as claimed in claim 18, comprising less than 5% by weight of water-soluble polymer.

20. A process for recycling a structure as defined in claim 1, wherein it comprises a step of grinding said structure and then washing it with hot water so as to dissolve and at least partially remove the water-soluble polymer from said structure in order to obtain the other constituents of said structure.

21. The process as claimed in claim 20, wherein it comprises a step of extrusion or injection of the other constituents of said structure.

22. The process as claimed in claim 21, wherein the injection or extrusion step is preceded by a compounding step.

23. The process as claimed in claim 21, wherein the injection or extrusion step allows the production of another tank, hose or tube.
